(19) United States
(12) Patent Application Publication
(10) Pub. No.: US 2017/0238261 A1
(43) Pub. Date: Aug. 17, 2017

(54) BASE STATION, USER EQUIPMENT, AND RADIO COMMUNICATION SYSTEM

(71) Applicant: NTT DOCOMO, INC., Tokyo (JP)

(72) Inventors: Anass BENJEBBOUR, Chiyoda-ku (JP); Yoshihisa KISHIYAMA, Chiyoda-ku (JP)

(73) Assignee: NTT Docomo, Inc., Tokyo (JP)

(21) Appl. No.: 15/502,710

(22) PCT Filed: Jun. 12, 2015
(86) PCT No.: PCT/JP2015/066998

§ 371 Date: Feb. 8, 2017

(30) Foreign Application Priority Data
Aug. 21, 2014 (JP) 2014-168299

(51) Int. Cl. H04W 52/14; H04B 7/0456; H04L 5/00; H04W 72/04

(52) U.S. Cl. CPC H04W 52/143; H04W 72/04; H04B 7/0456; H04L 5/0048

(57) ABSTRACT

A base station determines transmission powers for streams to be transmitted to UEs, performs precoding on data signals and demodulation reference signals (DM-RSs), transmits a mixed data signal with non-orthogonal data signals respectively addressed to the UEs being mixed, and also transmits the DM-RSs. The base station allocates resource elements to be shared by the UEs to the DM-RSs for the UEs regardless of whether the numbers of streams to be transmitted to the UEs are the same. If the numbers of streams to be transmitted to the UEs are different, the base station allocates, as the shared resource elements, resource elements that are appropriate for a UE to which a larger number of streams are to be transmitted, to the DM-RSs for the UEs, and equalizes the transmission powers at the shared resource elements.

### TECHNICAL FIELD

The present invention relates to a base station, a user equipment, and a radio communication system.

### BACKGROUND ART

Orthogonal multiple access (OMA), in which multiple signals do not interfere with each other, is widely used in communication between a base station and user equipments (e.g., mobile stations) in a mobile communication network. With orthogonal multiple access, different radio resources are allocated to different user equipments. CDMA (code division multiple access), TDMA (time division multiple access), and OFDMA (orthogonal frequency division multiple access) are examples of orthogonal multiple access. For example, in Long Term Evolution (LTE) standardized by the 3GPP, OFDMA is used in downlink communication. With OFDMA, different frequencies are allocated to different user equipments.

In recent years, non-orthogonal multiple access (NOMA) has been proposed as a method for communication between a base station and user equipments (e.g., see Patent Document 1). With non-orthogonal multiple access, the same radio resources are allocated to different user equipments. More specifically, a single frequency is allocated to different user equipments at the same time. In the case of applying non-orthogonal multiple access to downlink communication, a base station transmits a signal with a large transmission power to a user equipment (commonly a user equipment at a cell area edge) with a large path loss, i.e., a user equipment with a small reception SINR (signal-to-interference-plus-noise-power ratio), and the base station transmits a signal with a small transmission power to a user equipment (commonly a user equipment at the center of a cell area) with a small path loss, i.e., a user equipment with a large reception SINR. Accordingly, the signal received by each user equipment is influenced by interference caused by signals addressed to other user equipments.

In this case, each user equipment demodulates the signal addressed to that user equipment using a power difference. Specifically, each user equipment first demodulates the signal with the highest reception power. Because this demodulated signal is a signal addressed to a user equipment closest to the cell area edge (or more accurately, the user equipment with the lowest reception SINR), the user equipment closest to the cell area edge (the user equipment with the lowest reception SINR) ends demodulation. Each of the other user equipments cancels out the interference component corresponding to that demodulated signal in the received signals using an interference canceler, and demodulates the signal with the second-highest reception power. Because this demodulated signal is a signal addressed to a user equipment that is the second-closest to the cell area edge (or more accurately, the user equipment with the second-lowest reception SINR), the user equipment that is the second-closest to the cell area edge (has the second-lowest reception SINR) ends demodulation. By thus repeating the demodulation and canceling out of signals with high power, all of the user equipments can demodulate the signals addressed to them.

By combining non-orthogonal multiple access with orthogonal multiple access, it is possible to increase the capacity of the mobile communication network in comparison to using orthogonal multiple access alone. That is, in the case of using orthogonal multiple access alone, it is not possible to allocate a certain radio resource (e.g., a frequency) to multiple user equipments at the same time. In contrast, in the case of combining non-orthogonal multiple access and orthogonal multiple access, a certain radio resource can be allocated to multiple user equipments at the same time.

MIMO (Multiple Input Multiple Output) is used in mobile communication networks. In MIMO, precoding is performed at a base station in order to perform multi-stream beamforming thereat.

In LTE (Long Term Evolution) Advanced, i.e., LTE Release 10 and later of the 3GPP, a reference signal called a DM-RS (Demodulation Reference Signal) is defined for downlink (Non-Patent Document 1). A demodulation reference signal supports up to eight transmission streams that can be transmitted from a base station (cell). The demodulation reference signal is used to demodulate a data signal unique to a mobile communication terminal (user equipment; UE). The demodulation reference signal is precoded similarly to the data signal. For this reason, a UE can demodulate the data signal using the demodulation reference signal without precoding information.

### RELATED ART DOCUMENTS

### Patent Document

Patent Document 1: Japanese Patent Application Laid-Open Publication No. 2013-009290

### Non-Patent Document

Non-Patent Document 1: 3GPP TS 36.211 V10.7.0 (2013-02), 3rd Generation Partnership Project; Technical Specification Group Radio Access Network; Evolved Universal Terrestrial Radio Access (E-UTRA); Physical Channels and Modulation (Release 10), February 2013

### SUMMARY OF THE INVENTION

### Problem to be Solved by the Invention

In a system that combines non-orthogonal multiple access with OFDMA, in the case of further combining therewith the idea of single-user MIMO (SU-MIMO) (in the case of transmitting multiple layers to a UE by using multiple beams), it is favorable to set the number of streams of data signals transmitted to a UE from the base station equal to the number of demodulation reference signals for that UE, and also the transmission power for the demodulation reference signal in each stream equal to the transmission power for the data signal.

However, in the case of combining the idea of SU-MIMO, the number of streams to be transmitted to one UE may differ from the number of streams to be transmitted to another UE. In this case, the number of demodulation reference signals for the one UE also differs from the number of demodulation reference signals for the other UE. To change the number of demodulation reference signals, it is conceivable to change the number of resource elements for transmitting the demodulation reference signals. However, if the number of demodulation reference signals to be transmitted with one resource element differs from the number of demodulation reference signals to be transmitted with another resource element, the transmission powers at these resource elements will differ from each other.

In OFDMA, subcarriers are orthogonal to one another. Therefore, in theory, signal interference does not occur between adjacent subcarriers. However, in practice, a reference signal interferes with a data signal at a UE, which is on the reception side of downlink transmission. If the transmission power at a resource element with which the demodulation reference signal is transmitted is greater than or equal to a certain value, the quality of data signal reception by a UE will degrade.

The present invention provides a base station for stabilizing the quality of data signal reception by a user equipment, and a user equipment and a radio communication system that are suitable for this base station.

### Means of Solving the Problems

A base station according to the present invention is a base station including: a downlink transmission power determiner configured to allocate different downlink transmission powers to a plurality of user equipments, wherein one of the different downlink transmission powers is allocated to each of the plurality of user equipments in accordance with reception qualities of the user equipments; a stream transmission power determiner configured to determine, in accordance with the number of streams to be transmitted to each of the plurality of user equipments and the downlink transmission powers determined by the downlink transmission power determiner, transmission powers for respective streams to be transmitted to the plurality of user equipments; a precoder configured to perform different precodings on data signals addressed to the plurality of user equipments, and perform, on each of demodulation reference signals to be transmitted in the respective streams in which the data signals are transmitted, the same precoding as the precoding performed on the corresponding data signal; a radio transmitter configured to transmit a mixed data signal in which a plurality of non-orthogonal data signals addressed to respective ones of the plurality of user equipments are mixed, such that the data signals are transmitted in the respective streams, with the transmission powers determined by the stream transmission power determiner, the radio transmitter further being configured to transmit the demodulation reference signals; and a resource element allocator configured to allocate the demodulation reference signals to the streams to be transmitted to the user equipments, and determine, in accordance with the number of streams to be transmitted to one of the user equipments and the number of streams to be transmitted to an other of the user equipments, transmission powers for the demodulation reference signals for each of the one and other user equipments, to determine the number of resource elements to be allocated to the demodulation reference signals for each of the one and other user equipments.

A user equipment according to the present invention is a user equipment including: a radio receiver configured to receive a desired data signal and a demodulation reference signal from a base station; a non-orthogonal signal canceler configured to, if the radio receiver receives from the base station a mixed data signal that includes a plurality of non-orthogonal data signals respectively addressed to a plurality of user equipments and having different powers and when a power of the desired data signal addressed to the subject user equipment is lower than a power of one non-orthogonal data signal, out of the non-orthogonal data signals, addressed to an other user equipment, cancel out, from the mixed signal, a replica signal that is equivalent to the non-orthogonal data signal mixed with the desired data signal; a desired data signal demodulator configured to demodulate the desired data signal by using the demodulation reference signal received by the radio receiver; a demodulation reference signal recognizer configured to reference different resource elements in accordance with the number of streams transmitted to the user equipment from the base station, to recognize a demodulation reference signal of each stream; and a channel estimator configured to estimate a downlink channel matrix based on the demodulation reference signal of each stream recognized by the demodulation reference signal recognizer. If the radio receiver receives, from the base station, the desired data signal that is not mixed with the non-orthogonal signal, the channel estimator does not adjust the channel matrix, and if the radio receiver receives, from the base station, the mixed data signal that includes the non-orthogonal data signals respectively addressed to the user equipments and having different powers, the channel estimator adjusts the channel matrix in accordance with the number of streams transmitted to each user equipment from the base station.

### Effect of the Invention

In accordance with the number of streams to be transmitted to one user equipment and the number of streams to be transmitted to another user equipment, the base station according to the present invention determines the transmission powers for the demodulation reference signals for these user equipments, and determines the number of resource elements to be allocated to the demodulation reference signals for these user equipments. Accordingly, even if the number of streams differs between the user equipments and the number of demodulation reference signals differs between the user equipments, the transmission powers at the shared resource elements for the demodulation reference signals can be equalized. As a result, the quality of data signal reception at the user equipments is stabilized.

The user equipment according to the present invention includes the channel estimator for estimating a downlink channel matrix based on a demodulation reference signal of each stream. If the radio receiver receives, from the base station, the desired data signal that is not mixed with a non-orthogonal signal, the channel estimator does not adjust the channel matrix. If the radio receiver receives, from the base station, a mixed data signal mixed with non-orthogonal multiple data signals respectively addressed to multiple user equipments and having different powers, the channel estimator adjusts the channel matrix in accordance with the number of streams transmitted to each user equipment from the base station. Accordingly, the channel matrix can be appropriately adjusted even in a case where the number of streams differs between the user equipments and the number of demodulation reference signals differs between the user equipments but the transmission powers at the resource elements for the demodulation reference signals are equalized by the base station.

### BRIEF DESCRIPTION OF THE DRAWINGS

FIG. 1 is a schematic diagram showing a base station and user equipments for describing an overview of non-orthogonal multiple access.

FIG. 2 is a diagram showing an example of allocation of downlink transmission powers to user equipments by a base station in non-orthogonal multiple access.

FIG. 3 is a diagram showing another example of allocation of downlink transmission powers to user equipments by a base station in non-orthogonal multiple access.

FIG. 4 is a diagram showing an overview of combination of non-orthogonal multiple access and MIMO.

FIG. 5 is a diagram showing an example of conventional allocation of DM-RSs to a resource block RB in the case of transmitting up to two streams from the base station without applying non-orthogonal multiple access.

FIG. 6 is a diagram showing an example of conventional allocation of DM-RSs to a resource block RB in the case of transmitting up to four streams from the base station without applying non-orthogonal multiple access.

FIG. 7 is a diagram showing an example of conventional allocation of DM-RSs to a resource block RB in the case of transmitting up to eight streams from the base station without applying non-orthogonal multiple access.

FIG. 8 is a diagram showing allocation of DM-RSs to a resource block RB in a case where a base station transmits one stream to each of two user equipments, i.e., transmits a total of two streams, through MIMO to which non-orthogonal multiple access is applied, according to a first embodiment of the present invention.

FIG. 9 is a diagram showing allocation of DM-RSs to a resource block RB in a case where a base station transmits two streams to each of two user equipments, i.e., transmits a total of four streams, through MIMO to which non-orthogonal multiple access is applied, according to the first embodiment of the present invention.

FIG. 10 shows an example of allocation of DM-RSs to a resource block RB in a case where a base station transmits one stream to one user equipment and transmits two streams to another user equipment, through MIMO to which non-orthogonal multiple access is applied.

FIG. 11 shows another example of allocation of DM-RSs to a resource block RB in a case where a base station transmits one stream to one user equipment and transmits two streams to another user equipment, through MIMO to which non-orthogonal multiple access is applied.

FIG. 12 shows allocation of DM-RSs to a resource block RB in a case where a base station transmits one stream to one user equipment and transmits two streams to another user equipment, through MIMO to which non-orthogonal multiple access is applied, according to the first embodiment of the present invention.

FIG. 13 is a diagram showing allocation of DM-RSs to a resource block RB in a case where a base station transmits one stream to each of two user equipments, i.e., transmits a total of two streams, through MIMO to which non-orthogonal multiple access is applied, according to a second embodiment of the present invention.

FIG. 14 is a diagram showing allocation of DM-RSs to a resource block RB in a case where a base station transmits two streams to each of two user equipments, i.e., transmits a total of four streams, through MIMO to which non-orthogonal multiple access is applied, according to the second embodiment of the present invention.

FIG. 15 shows allocation of DM-RSs to a resource block RB in a case where a base station transmits one stream to one user equipment and transmits two streams to another user equipment, through MIMO to which non-orthogonal multiple access is applied, according to the second embodiment of the present invention.

FIG. 16 is a block diagram showing a configuration of the base station according to an embodiment of the present invention.

FIG. 17 is a block diagram showing a configuration of the user equipment according to an embodiment of the present invention.

### MODES FOR CARRYING OUT THE INVENTION

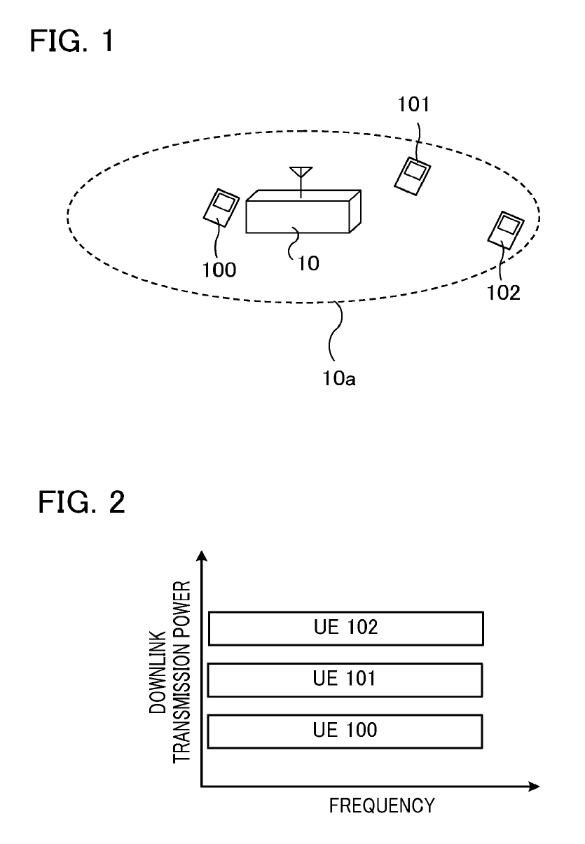

Hereinafter, various embodiments of the present invention will be described with reference to the accompanying drawings. First, an overview of non-orthogonal multiple access (NOMA) will be described. As shown in FIG. 1, a base station 10 communicates with multiple user equipments (UEs) 100 to 102. In FIG. 1, reference numeral 10a indicates a cell area of the base station 10. The UE 102 is at the cell area edge, i.e., the position closest to the boundary of the cell area 10a, is the farthest from the base station 10, and has the largest path loss (i.e., has the smallest reception SINR). The UE 100 is near the center of the cell area 10a, is the closest to the base station 10, and has the smallest path loss (i.e., has the largest reception SINR). The UE 101 is closer to the base station 10 than the UE 102 is, and is farther from the base station 10 than the UE 100 is.

FIG. 2 is a diagram showing an example of allocation of downlink transmission powers to the UEs by the base station in NOMA. The base station 10 performs downlink data transmission using the same frequency at the same time for the UEs 100 to 102. In other words, the same frequency and the same time period are allocated to the UEs 100 to 102. The base station 10 uses the highest downlink transmission power to perform transmission to the UE 102, which is the most remotely-located, and uses the lowest downlink transmission power to perform transmission to the UE 100, which is located the closest to the base station 10.

Note that the UEs connected to the base station 10 are not limited to the UEs 100 to 102. NOMA can be combined with orthogonal multiple access, and a frequency different from the frequency allocated to the UEs 100 to 102 may be allocated to UEs other than the UEs 100 to 102. The number of UEs to which the same frequency is allocated at the same time (number of UEs to be multiplexed using NOMA) is not limited to being three, and may be two, four, or more.

From the standpoint of the UEs 100 to 102, the data signal with the highest reception power is the data signal addressed to the UE 102, and the data signal with the lowest reception power is the data signal addressed to the UE 100. The UEs 100 to 102 each first demodulate the data signal with the highest reception power. Because this demodulated data signal is the data signal addressed to the UE 102, which is at the position that is the closest to the boundary of the cell area 10a, the UE 102 ends demodulation and uses this demodulated data signal. The other UEs 100 and 101 each use an interference canceler to remove, from the received signal, the interference component (replica signal) corresponding to the demodulated data signal, and demodulate the data signal with the second-highest reception power. Because this demodulated data signal is the data signal addressed to the UE 101, which is at the position that is second-closest to the boundary of the cell area 10a, the UE 101 ends demodulation and uses this demodulated data signal. By thus repeating the demodulation and canceling out of the data signals with high reception powers as necessary, all of the UEs 100 to 102 can demodulate the data signals addressed to them. Thus, with NOMA, a UE cancels out the data signal (interference signal) that is transmitted from the serving base station and are addressed to other UEs until the data signal addressed to that UE is demodulated.

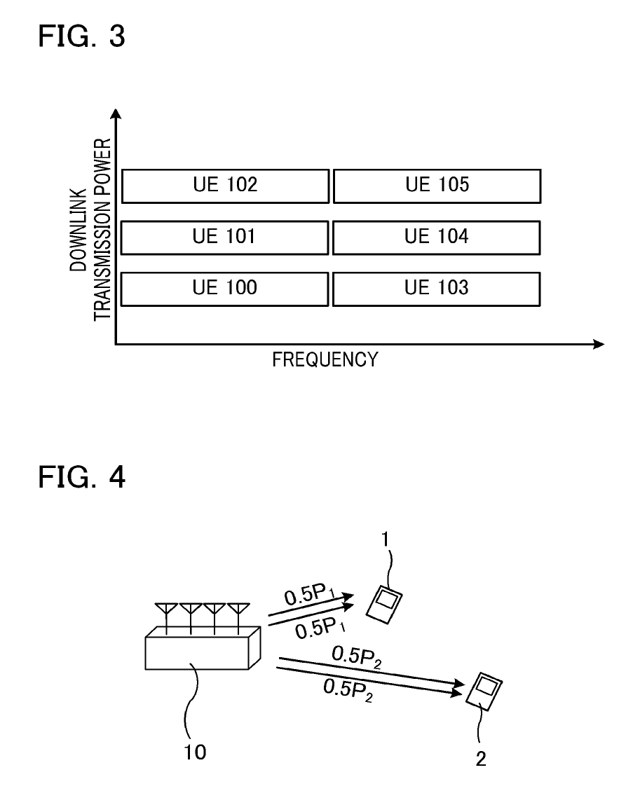

FIG. 3 shows another example of allocation of downlink transmission powers to user equipments by the base station with NOMA. UEs 100 to 102 constitute one group of data apparatuses with different transmission powers, and UEs 103 to 105 constitute another group of data apparatuses with different transmission powers. A UE with a low reception power (e.g., UE 103) demodulates the data signals addressed to other UEs that belong to the same group as that UE and having higher reception powers (e.g., UEs 104 and 105), and cancels out replica signals that result from the demodulation.

FIG. 4 shows an overview of combination of NOMA and SU-MIMO (a method of transmitting multiple layers to each UE by using multiple beams). The base station 10 can transmit multiple streams (layers or ranks) to each UE by performing precoding. In FIG. 4, in the case of providing two transmission antennas in the base station and two reception antennas in each UE, and multiplexing the two UEs 1 and 2 using NOMA, a total of four streams can be transmitted. The UE 1, which is closer to the base station 10, cancels out a replica signal corresponding to the signal with a high power for the UE 2, and demodulates the desired signal addressed to the UE 1. The following description will assume the use of SU-MIMO (a method of transmitting multiple layers to a UE by using multiple beams) with NOMA. On the other hand, in the case of combining MU-MIMO (a method of transmitting multiple layers to each of multiple UEs by using multiple beams) with NOMA, mapping of user specific reference signals corresponding to the number of streams and the number of users to be multiplexed is required.

In the case of MIMO, the transmission power for each stream to be transmitted to a UE is obtained by equally dividing the transmission power for the UE by the number of streams. This is called EQPA (equal power allocation). For example, when the transmission power for the UE 1 is P₁ and two streams are to be transmitted to the UE 1, the transmission power for each stream is 0.5 P₁. If one stream is to be transmitted to the UE 1, the transmission power for this stream is P₁. When the transmission power for the UE 2 is P₂ and two streams are to be transmitted to the UE 2, the transmission power for each stream is 0.5 P₂. If one stream is to be transmitted to the UE 2, the transmission power for this stream is P₂.

The number of streams for a UE is selected by the UE using known rank adaptation. That is, a UE feeds back rank information (rank indicator; RI) indicating the optimum number of streams to the base station 10 based on, for example, the reception SINR. The base station 10 controls the number of streams to be transmitted to each of UEs based on the rank information. The number of streams for a UE with good reception quality may be increased, whereas only a small number of streams can be allocated to a UE with poor reception quality. Determination of the rank may be made by the base station, rather than by the UE. In this case, if the rank of the UE with respect to an eNB is 1 or 2, CQI and PMI information for either case may be fed back to the base station, and the base station may determine the appropriate rank in tune with other UE(s) to be paired using NOMA, to notify the UE to that effect.

The transmission powers P₁ and P₂ for the UEs 1 and 2 are determined by the base station 10 based on the reception qualities (e.g., reception SINRs) of these UEs. In the case of 1×2 SIMO (Single Input Multiple Output), the base station 10 uses Equation (1) below, for example, to determine a downlink data signal transmission power Pₖ for each UE.

$${P}_{k} = \frac{P}{{\sum }_{i = 1}^{K} {( {\vert {h}_{i} \vert}^{2} / {N}_{i} )}^{- α}} {( \frac{{\vert {h}_{k} \vert}^{2}}{{N}_{k}} )}^{- α} \qquad ( 1 )$$

In Equation (1), P indicates the total of the downlink data signal transmission powers for all UEs for which the same frequency is used at the same time (total downlink data signal transmission power). The suffix k of the parameters identifies a UE for which the downlink data signal transmission power Pₖ is determined, and the suffix i of the parameters identifies a UE for the summation in Equation (1). K indicates the number of all UEs for which the same frequency is used at the same time (the number of UEs to be multiplexed using NOMA). h indicates a downlink channel coefficient for the UEs, and N indicates the total of a thermal noise power at the UEs and an interference power from other base stations.

$$\frac{{\vert {h}_{i} \vert}^{2}}{{N}_{i}}$$

corresponds to the SINR of a UEᵢ. The base station can find this SINR from the CQI (channel quality indicator) reported by the UEᵢ. In Equation (1), α indicates a coefficient for determining allocation of the downlink data signal transmission power, and is greater than 0 and less than or equal to 1. Because a is greater than 0 and less than or equal to 1, a smaller downlink data signal transmission power is allocated to a UE with a larger SINR (with better reception quality). The closer α is to 1, the larger the difference in the transmission powers for the UEs relative to the difference in the reception SINRs in the UEs is.

Alternatively, the base station 10 may search for the power set {P₁, P₂} that maximizes the scheduling metric, by using full search power allocation (FSPA), which is described in A. Benjebbour, A. Li, Y. Saito, Y. Kishiyama, A. Harada, and T. Nakamura, “System-level performance of downlink NOMA for future LTE enhancements,” IEEE Globecom, December 2013, and determine the downlink data signal transmission powers for the UEs.

In the example of 2×2 MIMO in FIG. 4, P=P₁+P₂ holds. For example, in a case where the transmission power P₁ for the UE 1 is 0.2 P and the transmission power P₂ for the UE 2 is 0.8 P, if two streams are to be transmitted to the UE 1, the transmission power for each stream is 0.1 P. If two streams are to be transmitted to the UE 2, the transmission power for each stream is 0.4 P.

Two transmission antennas of one base station 10 transmitting two streams to each of two UEs can be considered to be 2×2 MIMO. In this case, the signal received by each UE: Y is a 2×1 matrix, and is expressed by Equation (2) below.

Y=HW₁\sqrt{P₁}S₁+HW₂\sqrt{P₂}S₂+N (2)

Here, H indicates a channel matrix, and is a 2×2 matrix in 2×2MIMO. W₁ indicates a precoding matrix for the UE 1, and is applied to all streams addressed to the UE 1. W₂ indicates a precoding matrix for the UE 2, and is applied to all streams addressed to the UE 2. S₁ indicates a transmission data symbol addressed to the UE 1. S₂ indicates a transmission data symbol addressed to the UE 2. N indicates an interference power from other base stations and additive white Gaussian noise.

Equation (2) can be replaced with Equation (3).

Y=H₁S₁+H₂S₂+N (3)

where H₁ indicates an equivalent channel matrix for the UE 1, and is expressed by Equation (4).

H₁=HW₁\sqrt{P₁} (4)

H₂ indicates an equivalent channel matrix for the UE 2, and is expressed by Equation (5).

H₂HW₂\sqrt{P₂} (5)

As will be clearly understood from the above, each UE can demodulate a transmitted data signal (desired data signal) addressed to the UE if the UE can estimate the equivalent channel matrix (expressed by Equation (4) and Equation (5)) corresponding to this UE. A DM-RS is used to estimate the equivalent channel matrix. In 2×2 MIMO in which a total of four streams are transmitted as mentioned above, the base station 10 needs to use four DM-RS ports. That is, one DM-RS port is required for each layer (each stream). More specifically, the number of streams to be transmitted to each UE from the base station needs to be made equal to the number of DM-RSs for this UE.

To improve the accuracy in demodulating a desired data signal in UEs, it is conceivable to directly (i.e., explicitly) signal, to each UE, information regarding the transmission power for that UE. As a signaling means, for example, a PDCCH (physical downlink control channel) signal or an RRC (radio resource control) signal can be used. However, this will increase signaling overhead. In this case, the transmission powers for DM-RSs do not need to be controlled, and each DM-RS may be transmitted with the total downlink data signal transmission power P.

To reduce the signaling overhead, it is conceivable to indirectly (i.e., implicitly) signal, to each UE, the equivalent channel matrix addressed to that UE. For example, it is conceivable to make the transmission power for the DM-RS equal to the transmission power for the data signal in each stream. In this case, each UE can estimate the equivalent channel matrix (expressed by Equation (4) and Equation (5)) corresponding to the UE, based on the result of receiving DM-RSs. In this case, each UE is not notified of the transmission power for that UE, but can demodulate the transmitted data signal (desired data signal) addressed to the UE by estimating the equivalent channel matrix.

In the embodiments of the present invention, the transmission power for the DM-RS is made equal to the transmission power for the data signal in each stream. That is, in the example shown in FIG. 4, if two streams are transmitted to the UE 1, the transmission power for the data signal and the DM-RS in each stream is 0.5 P₁. If two streams are transmitted to the UE 2, the transmission power for the data signal and the DM-RS in each stream is 0.5 P₂. As mentioned above, in the case of making the transmission power for the DM-RS equal to the transmission power for the data signal, information regarding the transmission power for each UE does not need to be directly (i.e., explicitly) signaled to this UE. However, transmission power information may be signaled.

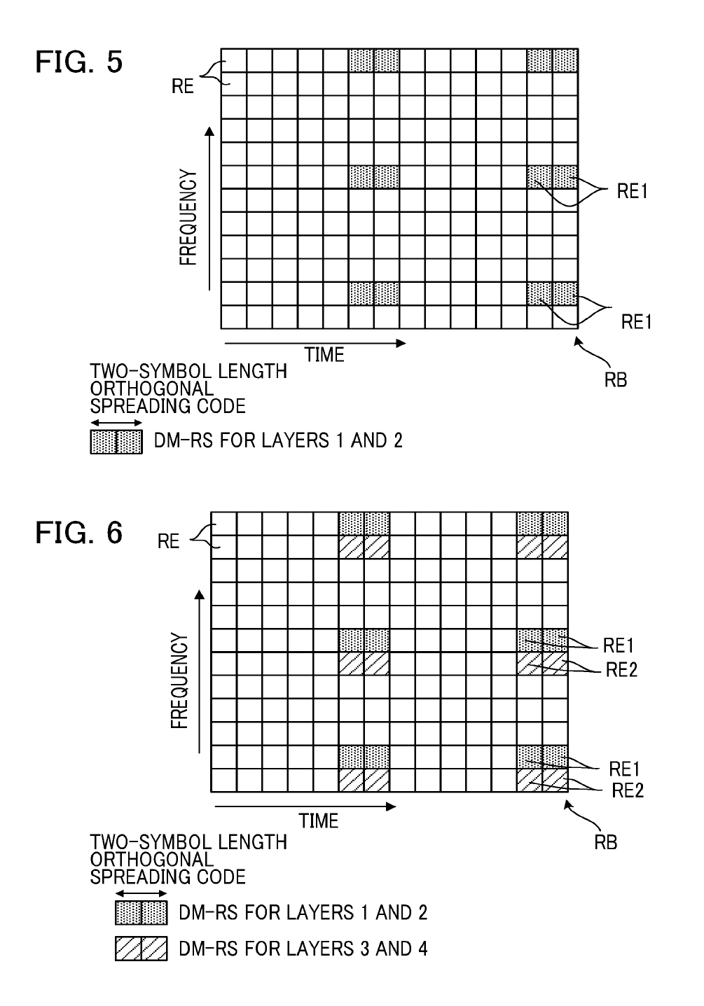

FIG. 5 shows an example of conventional allocation of DM-RSs to a resource block RB in the case of transmitting up to two streams (two layers) from a base station. In this example, the use of NOMA is not considered. That is, the base station uses OMA (orthogonal multiple access) using OFDMA to transmit up to two streams to a UE. In the case of providing two transmission antennas in the base station and two reception antennas in the UE and executing 2×2 SU-MIMO (a method of using multiple beams to transmit multiple layers to each UE), up to two streams (two layers) can be transmitted. In the diagram, each box indicates a resource element RE. One resource element RE corresponds to one OFDM symbol (time unit) and one OFDM subcarrier (frequency unit). In the diagram, colored resource elements RE1 are resource elements for transmitting DM-RSs. As shown in FIG. 5, shared resource elements RE1 are allocated to the DM-RSs for layers 1 and 2. These resource elements RE1 are on three subcarriers. To distinguish between the layers 1 and 2, a two-symbol length orthogonal spreading code is used (i.e., code division multiplexing is used, and the DM-RSs for the layers 1 and 2 are spread with a two-symbol length orthogonal spreading code). As is obvious from FIG. 5, 12 resource elements RE1 are used in one resource block RB to transmit the DM-RSs.

FIG. 6 shows an example of conventional allocation of DM-RSs to a resource block RB in the case of transmitting up to four streams (four layers) from a base station. In this example, the use of NOMA is not considered. That is, the base station uses OMA using OFDMA to transmit up to four streams to a UE. As shown in FIG. 6, DM-RSs for layers 1 and 2 are arranged on subcarriers that are different from subcarriers of DM-RSs for layers 3 and 4 (i.e., frequency division multiplexing is used). Shared resource elements RE1 are allocated to the DM-RSs for the layers 1 and 2, and these resource elements RE1 are on three subcarriers. To distinguish between the layers 1 and 2, a two-symbol length orthogonal spreading code is used (i.e., code division multiplexing is used, and the DM-RSs for the layers 1 and 2 are spread with a two-symbol length orthogonal spreading code). Shared resource elements RE2 are allocated to DM-RSs for the layers 3 and 4, and these resource elements RE2 are on three subcarriers. To distinguish between the layers 3 and 4, a two-symbol length orthogonal spreading code is used (i.e., code division multiplexing is used, and the DM-RSs for the layers 3 and 4 are spread with a two-symbol length orthogonal spreading code). As is obvious from FIG. 6, 24 resource elements RE1 and RE2 are used in one resource block RB to transmit the DM-RSs.

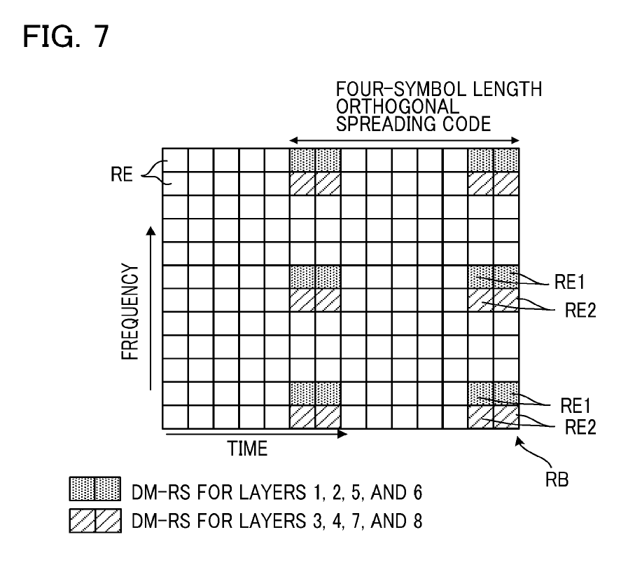

FIG. 7 shows an example of conventional allocation of DM-RSs to a resource block RB in the case of transmitting up to eight streams (eight layers) from a base station. In this example, the use of NOMA is not considered. That is, the base station uses OMA using OFDMA to transmit up to eight streams to a UE. As shown in FIG. 7, DM-RSs for layers 1, 2, 5, and 6 are arranged on subcarriers that are different from subcarriers of DM-RSs for layers 3, 4, 7, and 8 (i.e., frequency division multiplexing is used). Shared resource elements RE1 are allocated to the DM-RSs for the layers 1, 2, 5, and 6, and these resource elements RE1 are on three subcarriers. To distinguish among the layers 1, 2, 5, and 6, a four-symbol length orthogonal spreading code is used (i.e., code division multiplexing is used, and the DM-RSs for the layers 1, 2, 5, and 6 are spread with a four-symbol length orthogonal spreading code). Shared resource elements RE2 are allocated to the DM-RSs for the layers 3, 4, 7, and 8, and these resource elements RE2 are on three subcarriers. To distinguish among the layers 3, 4, 7, and 8, a four-symbol length orthogonal spreading code is used (i.e., code division multiplexing is used, and the DM-RSs for the layers 3, 4, 7, and 8 are spread with a four-symbol length orthogonal spreading code). As is obvious from FIG. 7, 24 resource elements RE1 and RE2 are used in one resource block RB to transmit the DM-RSs.

### First Embodiment

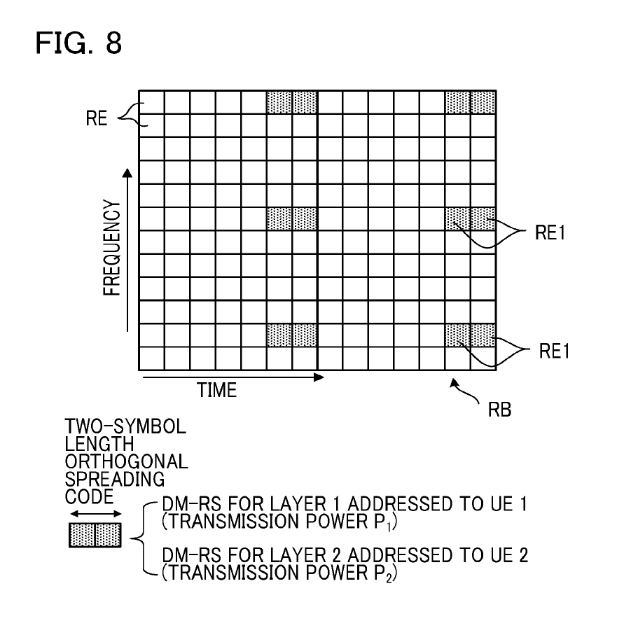

FIG. 8 shows allocation of DM-RSs to a resource block RB according to a first embodiment of the present invention in the case of transmitting one stream to each of two UEs, i.e., a total of two streams (two layers) from a base station through MIMO to which NOMA is applied. From the base station, a layer 1 is transmitted to the UE 1, and a layer 2 is transmitted to the UE 2. Two transmission antennas of one base station transmitting signals to the two UEs using NOMA can be considered to be rank-1 transmission of 2×2 SU-MIMO from the standpoint of each user.

The base station transmits a DM-RS for the layer 1 addressed to the UE 1, and transmits a DM-RS for the layer 2 addressed to the UE 2. The transmission power for the DM-RS for the layer 1 addressed to the UE 1 is the same as the transmission power for a data signal for the layer 1, and is P₁ (e.g., 0.2 P). The transmission power for the DM-RS for the layer 2 addressed to the UE 2 is the same as the transmission power for a data signal for the layer 2, and is P₂ (e.g., 0.8 P).

As shown in FIG. 8, shared resource elements RE1 are allocated to the DM-RS for the layer 1 addressed to the UE 1 and the DM-RS for the layer 2 addressed to the UE 2, and these resource elements RE1 are on three subcarriers. To distinguish between the layers 1 and 2, a two-symbol length orthogonal spreading code is used (i.e., code division multiplexing is used, and the DM-RSs for the layers 1 and 2 are spread with a two-symbol length orthogonal spreading code). As is obvious from FIG. 8, 12 resource elements RE1 are used in one resource block RB to transmit the DM-RSs. The transmission powers at the respective resource elements RE1 with which the DM-RSs are transmitted and that are shared by the UE 1 and the UE 2 are equal to one another, i.e., P₁+P₂.

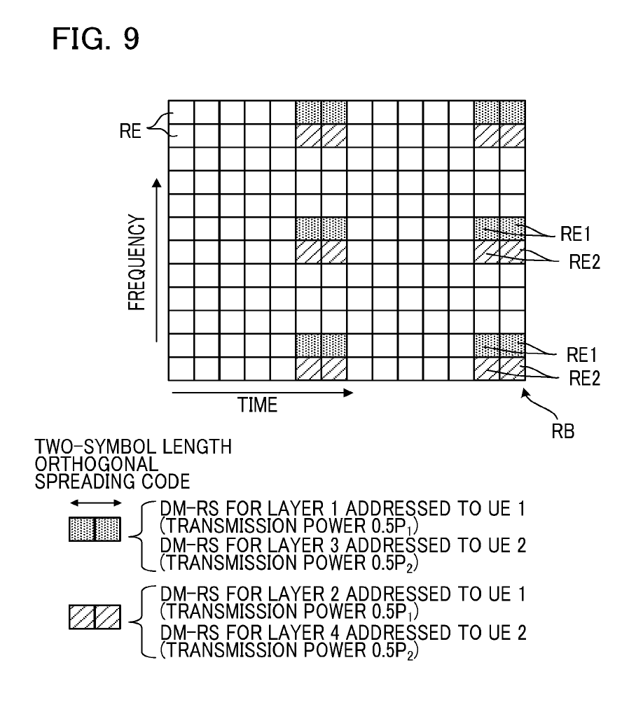

FIG. 9 shows allocation of DM-RSs to a resource block RB according to the first embodiment of the present invention in the case of transmitting two streams to each of two UEs, i.e., a total of four streams (four layers) from a base station through MIMO to which NOMA is applied. That is, layers 1 and 2 are transmitted to the UE 1 from the base station, and layers 3 and 4 are transmitted to the UE 2. With the combination of NOMA and 2×2 SU-MIMO, up to four streams (layers) can be multiplexed.

The base station transmits a DM-RS for the layer 1 addressed to the UE 1, transmits a DM-RS for the layer 2 addressed to the UE 1, transmits a DM-RS for the layer 3 addressed to the UE 2, and transmits a DM-RS for the layer 4 addressed to the UE 2. The transmission power for each of the DM-RSs for the layers 1 and 2 addressed to the UE 1 are the same as the transmission power for each data signal for the layers 1 and 2, and is 0.5 P₁ (e.g., 0.1 P). The transmission power for each of the DM-RSs for the layers 3 and 4 addressed to the UE 2 is the same as the transmission power for each data signal for the layers 3 and 4, and is 0.5 P₂ (e.g., 0.4 P).

As shown in FIG. 9, the DM-RSs for the layers 1 and 3 are arranged on subcarriers that are different from subcarriers of the DM-RSs for the layers 2 and 4 (i.e., frequency division multiplexing is used). Shared resource elements RE1 are allocated to the DM-RS for the layer 1 addressed to the UE 1 and the DM-RS for the layer 3 addressed to the UE 2, and these resource elements RE1 are on three subcarriers. To distinguish between the layers 1 and 3, a two-symbol length orthogonal spreading code is used (i.e., code division multiplexing is used, and the DM-RSs for the layers 1 and 3 are spread with a two-symbol length orthogonal spreading code). Shared resource elements RE2 are allocated to the DM-RS for the layer 2 addressed to the UE 1 and the DM-RS for the layer 4 addressed to the UE 2, and these resource elements RE2 are on three subcarriers. To distinguish between the layers 2 and 4, a two-symbol length orthogonal spreading code is used (i.e., code division multiplexing is used, and the DM-RSs for the layers 2 and 4 are spread with a two-symbol length orthogonal spreading code). As is obvious from FIG. 9, 24 resource elements RE1 and RE2 are used in one resource block RB to transmit the DM-RSs. The transmission powers at the respective resource elements RE1 and RE2 with which the DM-RSs are transmitted and that are shared by the UE 1 and the UE 2 are equal to one another, i.e., 0.5 P₁+0.5 P₂.

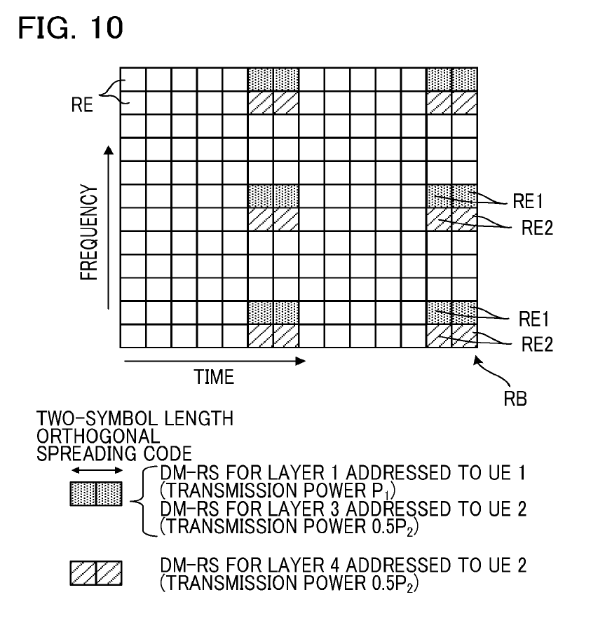

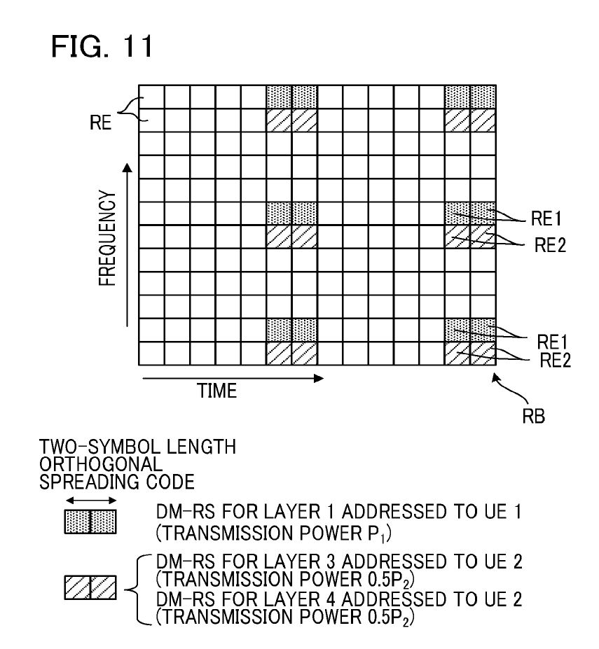

As described above, in a case where the number of streams to be transmitted to one UE is the same as that for another UE, it is easy to equalize the transmission powers at the respective shared resource elements RE1 with which the DM-RSs are transmitted. However, with MIMO, the number of streams to be transmitted to one UE may differ from the number of streams to be transmitted to another UE. In this case, the number of DM-RSs for the one UE also differs from the number of DM-RSs for the other UE. To change the number of DM-RSs, changing the number of resource elements for transmitting the DM-RSs may be conceived. FIGS. 10 and 11 show such examples.

FIG. 10 shows an example of allocation of DM-RSs to a resource block RB in a case where a base station transmits one stream (layer 1) to the UE 1 and transmits two streams (layers 3 and 4) to the UE 2 through MIMO to which NOMA is applied.

The base station transmits a DM-RS for the layer 1 addressed to the UE 1, transmits a DM-RS for the layer 3 addressed to the UE 2, and transmits a DM-RS for the layer 4 addressed to the UE 2. The transmission power for the DM-RS for the layer 1 addressed to the UE 1 is the same as the transmission power for a data signal for the layer 1, and is P₁ (e.g., 0.2 P). The transmission power for each of the DM-RSs for the layers 3 and 4 addressed to the UE 2 is the same as the transmission power for each data signal for the layers 3 and 4, and is 0.5 P₂ (e.g., 0.4 P).

As shown in FIG. 10, the DM-RSs for the layers 1 and 3 are arranged on subcarriers that are different from subcarriers for the DM-RS for the layer 4 (i.e., frequency division multiplexing is used). Resource elements RE1 on three subcarriers are allocated to the DM-RSs for the layer 1 addressed to the UE 1 and the DM-RSs for the layer 3 addressed to the UE 2. To distinguish between the layers 1 and 3, a two-symbol length orthogonal spreading code is used (i.e., code division multiplexing is used, and the DM-RSs for the layers 1 and 3 are spread with a two-symbol length orthogonal spreading code). Resource elements RE2 on three subcarriers are allocated to the DM-RSs for the layer 4 addressed to the UE 2. The DM-RSs for the layer 4 is also spread with a two-symbol length orthogonal spreading code. As is obvious from FIG. 10, 24 resource elements RE1 and RE2 are used in one resource block RB to transmit the DM-RSs.

In this case, however, the transmission power at each resource element RE1 with which the DM-RSs for the layers 1 and 3 addressed to the UE 1 and the UE 2 are transmitted is P₁+0.5 P₂, whereas the transmission power at each resource element RE2 with which only the DM-RS for the layer 4 addressed to the UE 2 is transmitted is 0.5 P₂. Thus, in a case in which the number of DM-RSs to be transmitted with a resource element differs from the number of DM-RSs to be transmitted with another resource element, the transmission powers at these resource elements will differ from each other.

In OFDMA, subcarriers are orthogonal to each other. Therefore, in theory, signal interference does not occur between adjacent subcarriers. However, in practice, a reference signal interferes with a data signal at a UE, which is on the reception side of downlink transmission. If the transmission powers at the resource elements with which DM-RSs are transmitted differ from each other, the quality of data signal reception by the UE will degrade.

FIG. 11 shows another example of allocation of DM-RSs to a resource block RB in a case where a base station transmits one stream (layer 1) to the UE 1 and transmits two streams (layers 3 and 4) to the UE 2 through MIMO to which NOMA is applied.

The base station transmits a DM-RS for the layer 1 addressed to the UE 1, transmits a DM-RS for the layer 3 addressed to the UE 2, and transmits a DM-RS for the layer 4 addressed to the UE 2. The transmission power for the DM-RS for the layer 1 addressed to the UE 1 is the same as the transmission power for a data signal for the layer 1, and is P₁ (e.g., 0.2 P). The transmission power for each of the DM-RSs for the layers 3 and 4 addressed to the UE 2 is the same as the transmission power for each data signal for the layers 3 and 4, and is 0.5 P₂ (e.g., 0.4 P).

As shown in FIG. 11, the DM-RS for the layer 1 is arranged on subcarriers that are different from subcarriers of the DM-RSs for the layers 3 and 4 (i.e., frequency division multiplexing is used). Resource elements RE1 on three subcarriers are allocated to the DM-RS for the layer 1 addressed to the UE 1. Resource elements RE2 on three subcarriers are allocated to the DM-RS for the layer 3 addressed to the UE 2 and the DM-RS for the layer 4 addressed to the UE 2. To distinguish between the layers 3 and 4, a two-symbol length orthogonal spreading code is used (i.e., code division multiplexing is used, and the DM-RSs for the layers 3 and 4 are spread with a two-symbol length orthogonal spreading code). The DM-RS for the layer 1 is also spread with a two-symbol length orthogonal spreading code. As is obvious from FIG. 11, 24 resource elements RE1 and RE2 are used in one resource block RB to transmit the DM-RSs.

However, in this case, the transmission power at each resource element RE1 with which the DM-RS for the layer 1 is transmitted is P₁ (e.g., 0.2 P), whereas the transmission power at each resource element RE2 with which the DM-RSs for the layers 3 and 4 are transmitted is P₂ (e.g., 0.8 P). Accordingly, in the example in FIG. 11 as well, similar to the example in FIG. 10, the transmission powers at the resource elements with which the DM-RSs are transmitted will differ from each other.

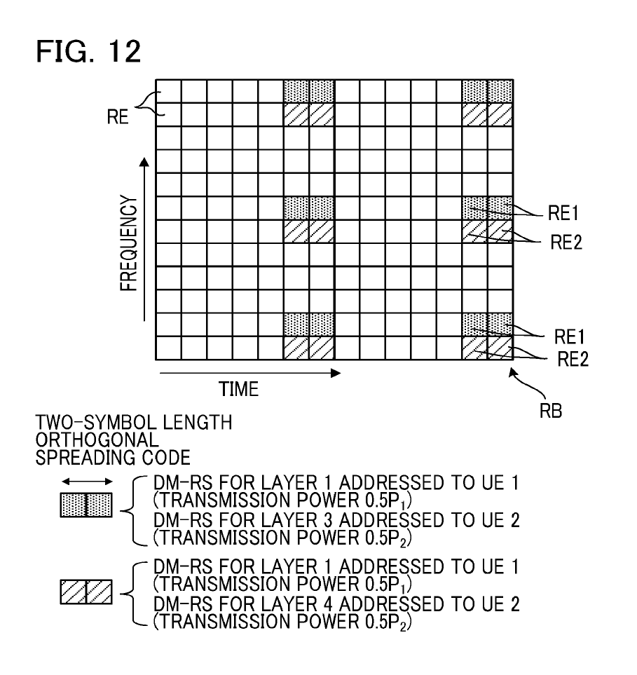

FIG. 12 shows allocation of DM-RSs to a resource block RB according to the first embodiment of the present invention in a case where a base station transmits one stream (layer 1) to a UE 1 and transmits two streams (layers 3 and 4) to a UE 2 through MIMO to which NOMA is applied.

The base station transmits a DM-RS for the layer 1 addressed to the UE 1, transmits a DM-RS for the layer 3 addressed to the UE 2, and transmits a DM-RS for the layer 4 addressed to the UE 2. As shown in FIG. 12, resource elements RE1 on three subcarriers are allocated to the DM-RS for the layer 3 addressed to the UE 2, and resource elements RE2 on three other subcarriers are allocated to the DM-RS for the layer 4 addressed to the UE 2 (i.e., the DM-RSs for the layers 3 and 4 are frequency division multiplexed). On the other hand, both the resource elements RE1 and the resource elements RE2 are redundantly allocated to the DM-RS for the layer 1 addressed to the UE 1.

Shared resource elements RE1 are allocated to the DM-RS for the layer 1 addressed to the UE 1 and the DM-RS for the layer 3 addressed to the UE 2. To distinguish between the layers 1 and 3, a two-symbol length orthogonal spreading code is used (i.e., code division multiplexing is used, and the DM-RSs for the layers 1 and 3 are spread with a two-symbol length orthogonal spreading code). Shared resource elements RE2 are allocated to the DM-RS for the layer 1 addressed to the UE 1 and the DM-RS for the layer 4 addressed to the UE 2. To distinguish between the layers 1 and 4, a two-symbol length orthogonal spreading code is used (i.e., code division multiplexing is used, and the DM-RSs for the layers 1 and 4 are spread with a two-symbol length orthogonal spreading code). As is obvious from FIG. 12, 24 resource elements RE1 and RE2 are used in one resource block RB to transmit the DM-RSs.

The transmission power for the DM-RS for the layer 1 addressed to the UE 1 that is redundantly transmitted with the resource elements RE1 and RE2 is 0.5 P₁ (e.g., 0.1 P), which is half the transmission power for a data signal for the layer 1. The transmission power for each of the DM-RSs for the layers 3 and 4 addressed to the UE 2 is the same as the transmission power for a data signal for each of the layers 3 and 4, and is 0.5 P₂ (e.g., 0.4 P). Accordingly, the transmission powers at the respective resource elements RE1 and RE2 with which the DM-RSs are transmitted and that are shared by the UE 1 and the UE 2 are equal to one another, i.e., 0.5 P₁+0.5 P₂.

As described above, in this embodiment, regardless of whether the number of streams to be transmitted to one UE is the same as the number of streams to be transmitted to another UE, shared resource elements are allocated to these UEs for DM-RSs for these UEs (see FIGS. 8, 9, and 12). Furthermore, in a case where the number of streams to be transmitted to one UE differs from the number of streams to be transmitted to another UE, resource elements RE1 and RE2 that are appropriate for the UE 2 to which a larger number of streams are to be transmitted are used as the resource elements to be shared by the UE 1 and the UE 2 and are allocated to the DM-RSs for the UE 1 and the UE 2 to equalize the transmission powers at the shared resource elements RE1 and RE2 (see FIG. 12). Accordingly, even if the number of streams differs between the UE 1 and the UE 2, and the number of DM-RSs differs between the UE 1 and the UE 2, the transmission powers at the respective shared resource elements for the DM-RSs can be equalized. As a result, the quality of data signal reception at each UE is stabilized.

In this embodiment in particular, in a case where the number of streams to be transmitted to one UE differs from the number of streams to be transmitted to another UE, multiple different resource elements RE1 and RE2 that correspond to different multiple subcarriers are allocated to DM-RSs of multiple streams for the UE 2 to which a larger number of streams are to be transmitted. The multiple resource elements RE1 and RE2 allocated to the UE 2 to which the larger number of streams are to be transmitted are redundantly allocated to a DM-RS of a single stream for the UE 1 to which a smaller number of streams are to be transmitted. As a result, the density of the DM-RSs is increased.

In this embodiment, if the number of streams to be transmitted to each UE is 1 (FIG. 8) or up to two (FIGS. 9 and 12), a two-symbol length orthogonal spreading code is used. Accordingly, the equivalent channel matrix can be estimated using a DM-RS with two consecutive OFDM symbols. With one resource block RB, the equivalent channel matrix can be estimated six times for each stream (layer). Regarding the layer 1 addressed to the UE 1 in FIG. 12, the equivalent channel matrix can be estimated 12 times with one resource block RB.

### Second Embodiment

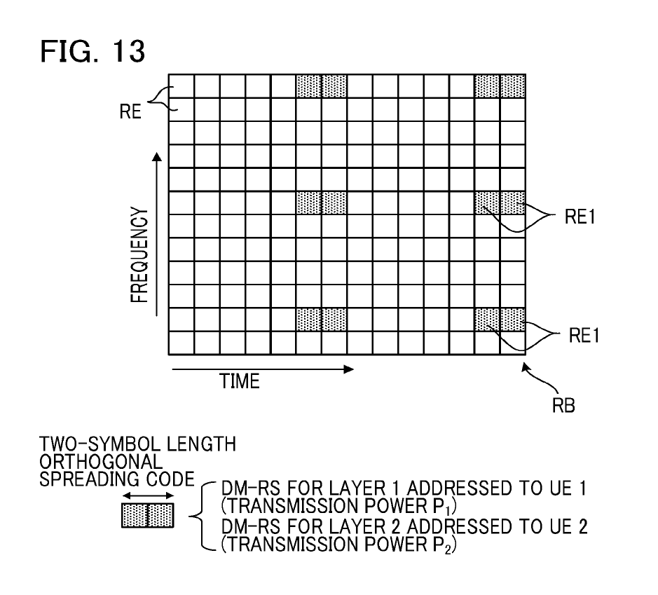

FIG. 13 shows allocation of DM-RSs to a resource block RB according to a second embodiment of the present invention in the case of transmitting one stream to each of two UEs, i.e., a total of two streams (two layers) from a base station through MIMO to which NOMA is applied. From the base station, a layer 1 is transmitted to a UE 1, and a layer 2 is transmitted to the UE 2. Two transmission antennas of one base station transmitting signals to each of the two UEs using NOMA can be considered to be 2×2 SU-MIMO from the standpoint of each user. FIG. 13 is the same as FIG. 8 in the first embodiment, and a description thereof will be omitted.

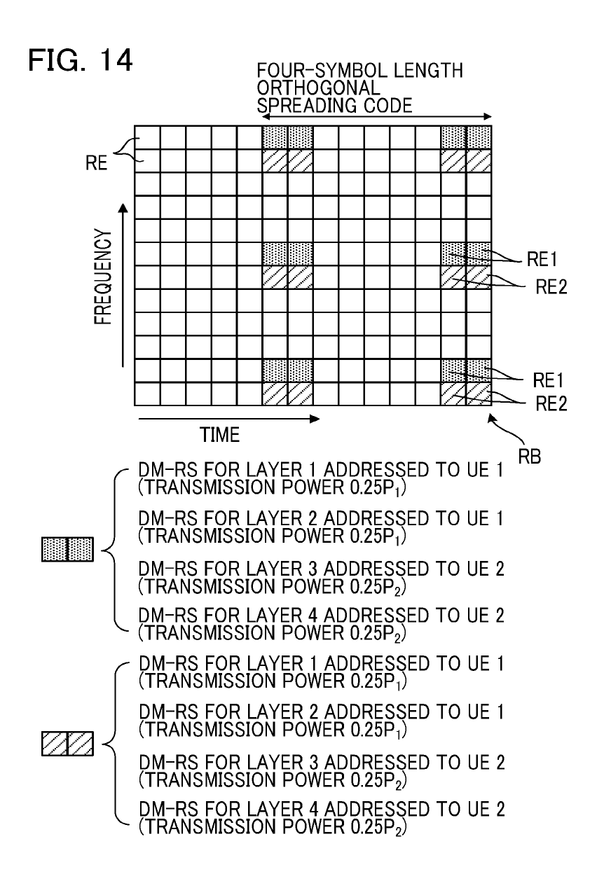

FIG. 14 shows allocation of DM-RSs to a resource block RB according to the second embodiment of the present invention in the case of transmitting two streams to each of two UEs, i.e., a total of four streams (four layers) from a base station through MIMO to which NOMA is applied. That is, from the base station, layers 1 and 2 are transmitted to the UE 1, and layers 3 and 4 are transmitted to the UE 2. With the combination of NOMA and 2×2 SU-MIMO, up to four streams (layers) can be multiplexed.

The base station transmits a DM-RS for the layer 1 addressed to the UE 1, transmits a DM-RS for the layer 2 addressed to the UE 1, transmits a DM-RS for the layer 3 addressed to the UE 2, and transmits a DM-RS for the layer 4 addressed to the UE 2. As shown in FIG. 14, resource elements RE1 on three subcarriers and resource elements RE2 on three other subcarriers are allocated to the DM-RSs for the layers 1 and 2 addressed to the UE 1 and the DM-RSs for the layers 3 and 4 addressed to the UE 2. That is, regardless of the UEs to which the DM-RSs are addressed, shared resource elements are allocated to the DM-RSs of all streams.

To distinguish among the layers 1, 2, 3, and 4, a four-symbol length orthogonal spreading code is used (i.e., code division multiplexing is used, and the DM-RSs for the layers 1, 2, 3, and 4 are spread with a four-symbol length orthogonal spreading code). As is obvious from FIG. 14, 24 resource elements RE1 and RE2 are used in one resource block RB to transmit the DM-RSs.

The transmission power for each of the DM-RSs for the layers 1 and 2 addressed to the UE 1 that are redundantly transmitted with the resource elements RE1 and RE2 is 0.25 P₁ (e.g., 0.05 P), which is half the transmission power for each of data signals for the layers 1 and 2. The transmission power for each of the DM-RSs for the layers 3 and 4 addressed to the UE 2 that are redundantly transmitted with the resource elements RE1 and RE2 is 0.25 P₂ (e.g., 0.2 P), which is half the transmission power for each of data signals for the layers 3 and 4. Accordingly, the transmission powers at the respective resource elements RE1 and RE2 with which the DM-RSs are transmitted and that are shared by the UE 1 and the UE 2 are equal to one another, i.e., 0.5 P₁+0.5 P₂.

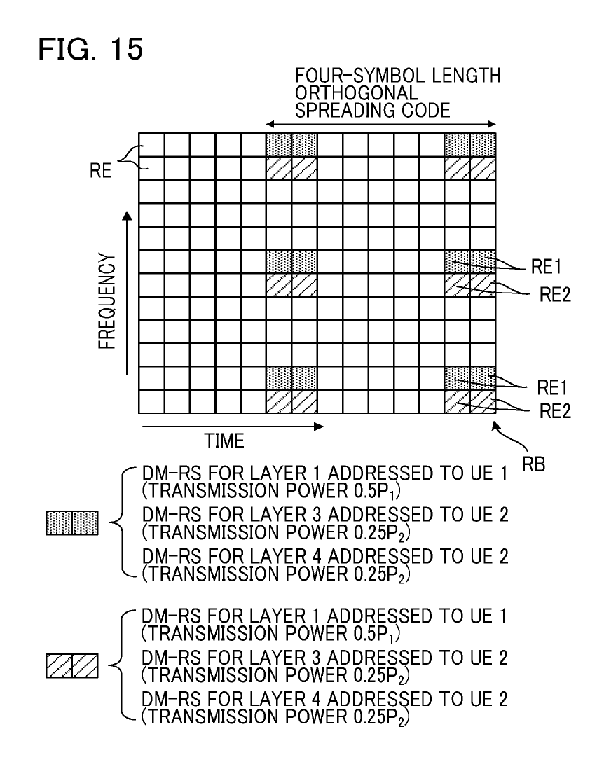

FIG. 15 shows allocation of DM-RSs to a resource block RB according to the second embodiment of the present invention in a case where a base station transmits one stream (layer 1) to a UE 1 and transmits two streams (layers 3 and 4) to a UE 2 through MIMO to which NOMA is applied.

The base station transmits a DM-RS for the layer 1 addressed to the UE 1, transmits a DM-RS for the layer 3 addressed to the UE 2, and transmits a DM-RS for the layer 4 addressed to the UE 2. As shown in FIG. 15, resource elements RE1 on three subcarriers and resource elements RE2 on three other subcarriers are allocated to the DM-RS for the layer 1 addressed to the UE 1 and the DM-RSs for the layers 3 and 4 addressed to the UE 2. That is, regardless of the UEs to which the DM-RSs are addressed, shared resource elements are allocated to the DM-RSs of all streams.

To distinguish among the layers 1, 3, and 4, a four-symbol length orthogonal spreading code is used (i.e., code division multiplexing is used, and the DM-RSs for the layers 1, 3, and 4 are spread with a four-symbol length orthogonal spreading code). As is obvious from FIG. 15, 24 resource elements RE1 and RE2 are used in one resource block RB to transmit the DM-RSs.

The transmission power for the DM-RS for the layer 1 addressed to the UE 1 that is redundantly transmitted with the resource elements RE1 and RE2 is 0.5 P₁ (e.g., 0.1 P), which is half the transmission power for a data signal for the layer 1. The transmission power for each of the DM-RSs for the layers 3 and 4 addressed to the UE 2 that are redundantly transmitted with the resource elements RE1 and RE2 is 0.25 P_{2 (e.g.,} 0.2 P), which is half the transmission power for each of data signals for the layers 3 and 4.

Accordingly, the transmission powers at the respective resource elements RE1 and RE2 with which the DM-RSs are transmitted and that are shared by the UE 1 and the UE 2 are equal to one another, i.e., 0.5 P₁+0.5 P₂.

As described above, in this embodiment, regardless of whether the number of streams to be transmitted to one UE is the same as the number of streams to be transmitted to another UE, resource elements to be shared by these UEs are allocated to the DM-RSs for these UEs (see FIGS. 13 to 15). In a case where the number of streams to be transmitted to one UE differs from the number of streams to be transmitted to another UE, resource elements RE1 and RE2 that are appropriate for the UE 2 to which a larger number of streams are to be transmitted are used as the resource elements to be shared by the UE 1 and the UE 2 and are allocated to the DM-RSs for the UE 1 and the UE 2 to equalize the transmission powers at the shared resource elements RE1 and RE2 (see FIG. 15). Accordingly, even if the number of streams differs between the UE 1 and the UE 2 and the number of DM-RSs differs between the UE 1 and the UE 2, the transmission powers at the respective shared resource elements for the DM-RSs can be equalized. As a result, the quality of data signal reception at each UE is stabilized.

In this embodiment in particular, regardless of the UEs to which the DM-RSs are addressed, shared resource elements are allocated to the DM-RSs of all streams (see FIGS. 13 to 15).

In this embodiment, in a case where the number of streams to be transmitted to each UE is 1 (FIG. 13), a two-symbol length orthogonal spreading code is used. Accordingly, the equivalent channel matrix can be estimated using a DM-RS with two consecutive OFDM symbols. With one resource block RB, the equivalent channel matrix can be estimated six times for each stream (layer). On the other hand, in a case where the number of streams to be transmitted to each UE is up to two (FIGS. 14 and 15), a four-symbol length orthogonal spreading code is used. Accordingly, the equivalent channel matrix can be estimated using a DM-RS with four OFDM symbols. With one resource block RB, the equivalent channel matrix can be estimated three times for each stream (layer).

Configuration of Base Station

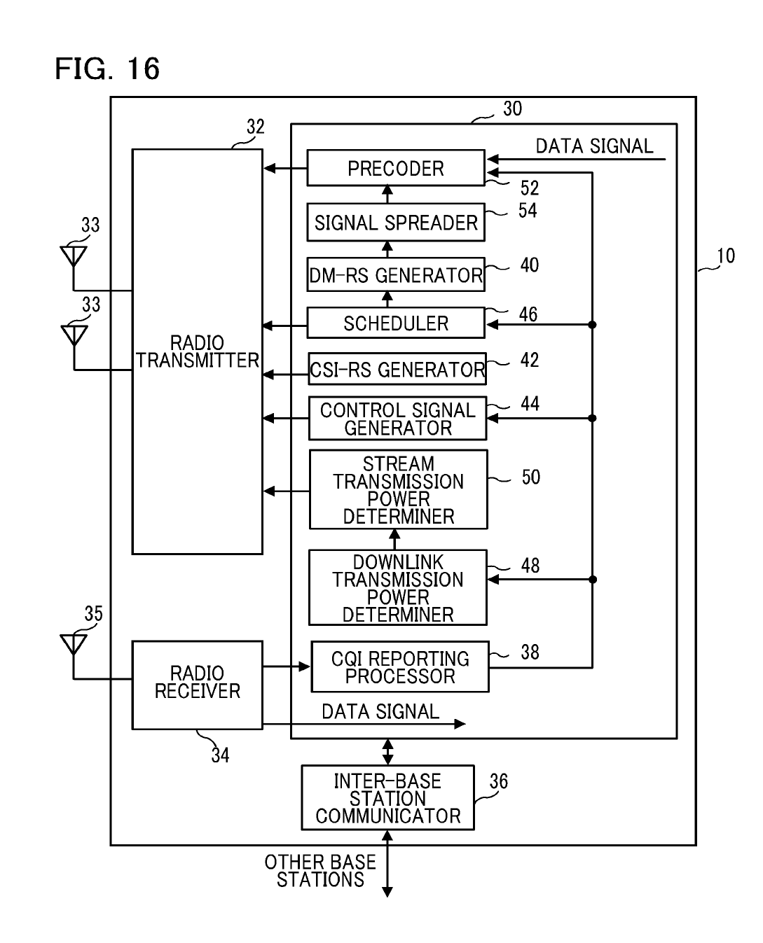

FIG. 16 is a block diagram showing a configuration of the base station according to an embodiment of the present invention. FIG. 16 is applied to both the above-described first and second embodiments. A base station 10 includes a controller 30, a radio transmitter 32, multiple transmission antennas 33, a radio receiver 34, a reception antenna 35, and an inter-base station communicator 36.

The radio transmitter 32 is a transmission circuit for converting an electrical signal into a radio wave to be transmitted from the transmission antennas 33 in order for the base station 10 to perform radio transmission to UEs. The transmission antennas 33 constitute an adaptive antenna array. The radio receiver 34 is a reception circuit for converting the radio wave received from the reception antenna 35 into an electrical signal in order for the base station 10 to perform radio reception from the UEs. The inter-base station communicator 36 is a communication interface for the base station 10 to perform communication with another base station.

The controller 30 includes a CQI reporting processor 38, a DM-RS generator 40, a CSI-RS generator 42, a control signal generator 44, a scheduler 46, a downlink transmission power determiner 48, a stream transmission power determiner 50, a precoder 52, and a signal spreader 54. The controller 30 is a CPU (central processing unit) that operates in accordance with a computer program. The internal components of the controller 30 are functional blocks that are realized due to the controller 30 functioning in accordance with the computer program.

The controller 30 processes uplink data signals that have been transmitted from the UEs connected to the base station 10 and have been received by the radio receiver 34. The CQI reporting processor 38 recognizes the SINRs in the UEs based on CQIs (channel quality indicators) that have been reported from the UEs connected to the base station 10 and have been received by the radio receiver 34.

The scheduler 46 determines the number of streams to be transmitted to the UEs based on RI (rank information) that has been reported from the UEs connected the base station 10 and has been received by the radio receiver 34.

The DM-RS generator 40 generates a DM-RS for each of these streams. Thus, the scheduler 46 and the DM-RS generator 40 function as a resource element allocator that allocates a DM-RS to each stream to be transmitted to the UEs.

The CSI-RS generator 42 generates a CSI-RS (channel state information reference signal).

The control signal generator 44 generates control signals (PDCCH signals) addressed to the UEs based on the SINRs in the UEs and other parameters.

Based on the SINRs in the UEs and/or the other parameters, the scheduler 46 determines the resource elements (frequency resources and time resources) for transmitting the downlink data signals that are respectively addressed to the multiple UEs connected to the base station 10. The scheduler 46 also determines whether to apply NOMA, and, in the case of applying NOMA, determines the UEs that are to be subjected to NOMA.

The downlink transmission power determiner 48 operates in a case where NOMA is applied. Based on the SINRs in the UEs, the downlink transmission power determiner 48 determines the downlink transmission powers to be used to transmit downlink data to the UEs that are connected to the base station 10 and subjected to NOMA. That is, the downlink transmission power determiner 48 allocates one of different downlink transmission powers to be used to transmit downlink data to each of the multiple UEs in accordance with the reception qualities of these UEs. The method for determining the downlink transmission power may be any known method relating to NOMA or method appropriate for NOMA. The downlink transmission power determiner 48 allocates a high downlink transmission power to a UE with low reception quality.

The stream transmission power determiner 50 operates in a case where NOMA is applied. The stream transmission power determiner 50 determines transmission powers for streams to be transmitted to the UEs based on the number of streams to be transmitted to each UE and the downlink transmission power determined by the downlink transmission power determiner 48.

The precoder 52 performs different precodings on respective data signals addressed to multiple UEs. The precoder 52 also performs the same precoding as the precoding performed on a data signal, on a DM-RS transmitted in a stream in which the data signal is transmitted.

The radio transmitter 32 transmits a mixed data signal, with multiple data signals that are respectively addressed to multiple UEs and are not orthogonal to each other being mixed, and also transmits corresponding DM-RSs, such that the data signals of the streams are transmitted with the transmission powers determined by the stream transmission power determiner 50. Accordingly, data signals are transmitted with different downlink transmission powers to the multiple UEs for which the same frequency is used at the same time in downlink transmission.

As mentioned above, the scheduler 46 and the DM-RS generator 40 allocate DM-RSs to streams to be transmitted to the UEs. The scheduler 46 also allocates resource elements to DM-RSs for multiple UEs in accordance with the number of streams to be transmitted to these UEs. Specifically, regardless of whether the number of streams to be transmitted to one UE is the same as the number of stream to be transmitted to another UE, the scheduler 46 allocates resource elements to be shared by these UEs to the DM-RSs for these UEs, as described above in association with the first embodiment and the second embodiment.

In a case where the number of streams to be transmitted to one UE differs from the number of streams to be transmitted to another UE, the scheduler 46 allocates resource elements that are appropriate for the UE to which a larger number of streams are to be transmitted, as the shared resource elements to DM-RSs for these UEs, and equalizes the transmission powers at the shared resource elements. Accordingly, the scheduler 46 (resource element allocator) determines the transmission powers for the DM-RSs for these UEs in accordance with the number of streams to be transmitted to each of these UEs, and determines the number of resource elements to be allocated to the DM-RSs for each of these UEs. As described above in association with the first embodiment, in a case where the number of streams to be transmitted to one UE differs from the number of streams to be transmitted to another UE, the scheduler 46 may allocate multiple different resource elements to DM-RS s of multiple streams for the UE to which a larger number of streams is to be transmitted. For the UE to which a smaller number of streams are to be transmitted, the scheduler 46 may redundantly allocate multiple resource elements allocated to the UE to which the larger number of streams is to be transmitted, to a DM-RS of a single stream. Alternatively, as described above in association with the second embodiment, the scheduler 46 may allocate shared resource elements to DM-RSs of all streams, regardless of the UEs to which the DM-RSs are addressed.

The signal spreader 54 spreads DM-RSs using an orthogonal spreading code for distinguishing the streams among the DM-RSs. With MIMO to which NOMA is applied, in the first embodiment, the signal spreader 54 uses a two-symbol length orthogonal spreading code if the number of streams to be transmitted to each UE is 1 (FIG. 8) or up to two (FIGS. 9 and 12). In the second embodiment, the signal spreader 54 uses a two-symbol length orthogonal spreading code in a case where the number of streams to be transmitted to each UE is 1 (FIG. 13), and uses a four-symbol length orthogonal spreading code in a case where the number of streams to be transmitted to each UE is up to two (FIGS. 14 and 15).

The base station 10 transmits signals not only for MIMO to which NOMA is applied, but also for MIMO to which NOMA is not applied. That is, the base station 10 needs to be adaptable to the transmission mode shown in FIGS. 5 to 7 to which NOMA is not applied as well. In a case where NOMA is not applied (i.e., OMA is applied), the downlink transmission power determiner 48 and the stream transmission power determiner 50 do not operate, and the base station 10 transmits a data signal and a DM-RS of each stream with a fixed power. Also, in a case where NOMA is not applied, the signal spreader 54 uses a two-symbol length orthogonal spreading code in transmitting up to four streams, and uses a four-symbol length orthogonal spreading code in transmitting five to eight streams.

In the case of 2×2 SU-MIMO with OMA (orthogonal multiplexing), the base station can transmit up to two streams (two layers) as described above in relation to FIG. 5. The scheduler 46 (resource element allocator) determines a fixed transmission power for the DM-RS of each stream. The scheduler 46 also determines resource elements to be allocated to the DM-RSs as resource elements RE1. In other words, the scheduler 46 determines the number of resource elements to be allocated to the DM-RSs.

In the case of 2×2 SU-MIMO with NOMA (non-orthogonal multiplexing), the base station can transmit up to four streams (four layers). The scheduler 46 determines the transmission powers for the DM-RS of each stream in various manners. The scheduler 46 also determines resource elements to be allocated to the DM-RSs as resource elements RE1 or as a set of resource elements RE1 and RE2. In other words, the scheduler 46 determines the number of resource elements to be allocated to the DM-RSs. As described above, the scheduler 46 determines the transmission powers for the DM-RSs for UEs in accordance with whether orthogonally or non-orthogonally multiplex streams are to be transmitted to the UEs, and determines the number of resource elements to be allocated to the DM-RSs for these UEs.

Configuration of UE

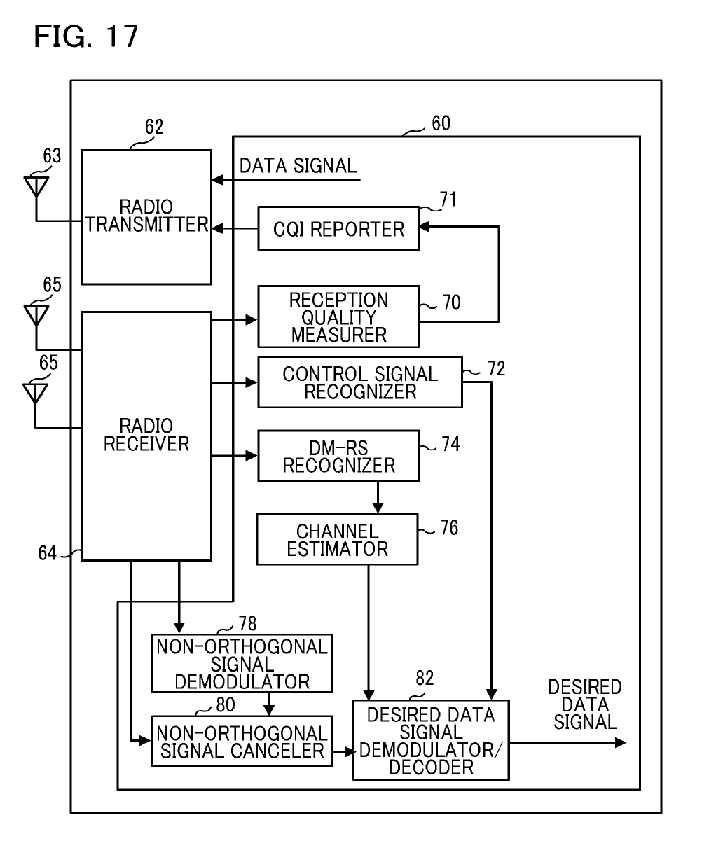

FIG. 17 is a block diagram showing a configuration of a UE according to an embodiment of the present invention. FIG. 17 is applied to both the above-described first and second embodiments. The UE includes a controller 60, a radio transmitter 62, a transmission antenna 63, a radio receiver 64, and multiple reception antennas 65.

The radio transmitter 62 is a transmission circuit for converting an electrical signal into a radio wave to be transmitted from the transmission antenna 63 in order for the UE to perform radio transmission to a serving base station. The radio receiver 64 is a reception circuit for converting the radio wave received from the reception antennas 65 into an electrical signal in order for the UE to perform radio reception from the serving base station. The reception antennas 65 constitute an adaptive antenna array.

The controller 60 includes a reception quality measurer 70, a CQI reporter 71, a control signal recognizer 72, a DM-RS recognizer 74, a channel estimator 76, a non-orthogonal signal demodulator 78, a non-orthogonal signal canceler 80, and a desired data signal demodulator/decoder (desired data signal demodulator) 82. These internal components of the controller 60 are functional blocks that are realized due to the controller 60 functioning in accordance with a computer program.

The controller 60 supplies an uplink data signal to the radio transmitter 62, and the radio transmitter 62 transmits the uplink data signal to the serving base station using the transmission antenna 63. The reception quality measurer 70 measures SINRs of radio signals, particularly CSI-RSs received by the radio receiver 64. The CQI reporter 71 generates CQT based on the SINRs and supplies the CQT to the radio transmitter 62. The radio transmitter 62 transmits the CQI to the serving base station over a control channel.

The radio receiver 64 receives a desired data signal, a CSI-RS, a DM-RS, and a control signal (PDCCH signal) from the sewing base station. If this UE is subjected to NOMA, the desired data signal addressed to the UE is included in a mixed data signal that is mixed with a non-orthogonal data signal addressed to another UE. In this case, the radio receiver 64 receives, from the serving base station, the mixed data signal that includes non-orthogonal multiple data signals that have different powers and are respectively addressed to multiple UEs.

The control signal recognizer 72 recognizes a control signal for the subject UE. The DM-RS recognizer 74 recognizes a DM-RS of each stream for the subject UE. The channel estimator 76 estimates the equivalent downlink channel matrix based on the DM-RS of each stream for the subject UE, wherein the DM-RS has been recognized by the DM-RS recognizer 74.

The non-orthogonal signal demodulator 78 operates in a case where the subject UE is subjected to NOMA. In this case, the radio receiver 64 receives, from the serving base station, a mixed data signal that includes non-orthogonal multiple data signals that have different powers and are respectively addressed to multiple UEs. If the power of a desired data signal addressed to the UE is lower than the power of a non-orthogonal data signal addressed to another UE, the non-orthogonal signal demodulator 78 demodulates the non-orthogonal data signal mixed with the desired data signal.

The non-orthogonal signal canceler 80 operates in a case where the UE is subjected to NOMA. If the power of a desired data signal addressed to the UE is lower than the power of a non-orthogonal data signal addressed to another UE, the non-orthogonal signal canceler 80 cancels out a replica signal that corresponds to the non-orthogonal data signal demodulated by the non-orthogonal signal demodulator 78 from the mixed data signal.

The desired data signal demodulator/decoder 82 demodulates and decodes a desired data signal from a signal output from the non-orthogonal signal canceler 80 in a case where this UE is subjected to NOMA and the power of the desired data signal addressed to this UE is lower than the power of the non-orthogonal data signal addressed to another UE. If it is not the case, the desired data signal demodulator/decoder 82 demodulates and decodes a desired data signal received by the radio receiver 64. In demodulation and decoding, the desired data signal demodulator/decoder 82 uses a control signal for the subject UE that is recognized by the control signal recognizer 72, and the equivalent channel matrix that is estimated by the channel estimator 76 and corresponds to the DM-RS for the subject UE.

The serving base station signals to the UE as to whether the UE is subjected to NOMA. Information regarding the rank order of the power for this UE among UEs subjected to NOMA is signaled from the serving base station to the UE. Information regarding the transmission power for the UE may or may not be directly (i.e., explicitly) signaled from the serving base station to the UE.

Resource elements that the DM-RS recognizer 74 is to reference to recognize a DM-RS for the UE differ depending on whether the UE is subjected to NOMA, and on the number of streams transmitted to each UE through MIMO. The symbol length of resource elements for a DM-RS to be used by the channel estimator 76 to estimate the equivalent channel matrix differs depending on whether the UE is subjected to NOMA (i.e., whether the UE receives a desired data signal that is mixed with a non-orthogonal signal from the base station, or receives a desired data signal that is not mixed with a non-orthogonal signal), and on the number of streams transmitted to each UE in MIMO.

In a case where the UE is not subjected to NOMA, if the number of transmission streams is up to two, the resource elements RE1 are allocated to the DM-RSs for that UE as shown in FIG. 5. The DM-RS recognizer 74 references the resource elements RE1 to recognize the DM-RSs. Because a two-symbol length orthogonal spreading code is used, the channel estimator 76 estimates the equivalent channel matrix using a DM-RS with two consecutive OFDM symbols. With one resource block RB, the channel estimator 76 estimates the equivalent channel matrix six times for each stream (layer).

In a case where the UE is not subjected to NOMA, if the number of transmission streams is three to eight, the resource elements RE1 and RE2 are allocated to DM-RSs for this UE as shown in FIGS. 6 and 7. The DM-RS recognizer 74 references the resource elements RE1 and RE2 to recognize the DM-RSs. If the number of transmission streams is three or four, a two-symbol length orthogonal spreading code is used as shown in FIG. 6. The channel estimator 76 thus estimates the equivalent channel matrix using a DM-RS with two consecutive OFDM symbols. With one resource block RB, the channel estimator 76 estimates the equivalent channel matrix six times for each stream (layer). If the number of transmission streams is five to eight, a four-symbol length orthogonal spreading code is used as shown in FIG. 7. The channel estimator 76 thus estimates the equivalent channel matrix using a DM-RS with four OFDM symbols. With one resource block RB, the channel estimator 76 estimates the equivalent channel matrix three times for each stream (layer).

In the first embodiment, in a case where the UE is subjected to NOMA and one stream is transmitted to each of two UEs from the base station, the resource elements RE1 are allocated to the DM-RSs for this UE as shown in FIG. 8. The DM-RS recognizer 74 references the resource elements RE1 to recognize the DM-RSs.

In the first embodiment, in a case where the subject UE is subjected to NOMA and two streams are transmitted to each of two UEs from the base station, the resource elements RE1 and RE2 are allocated to the DM-RSs for the subject UE as shown in FIG. 9. In a case where one stream is transmitted to one UE and two streams are transmitted to another UE from the base station, the resource elements RE1 and RE2 are allocated to the DM-RSs for the subject UE as shown in FIG. 12. In either case, the DM-RS recognizer 74 references the resource elements RE1 and RE2 to recognize the DM-RSs.

In the first embodiment, a two-symbol length orthogonal spreading code is used. The channel estimator 76 thus estimates the equivalent channel matrix using a DM-RS with two consecutive OFDM symbols. With one resource block RB, the equivalent channel matrix is estimated six times for each stream (layer). Regarding the layer 1 addressed to the UE 1 in FIG. 12, one resource block RB enables estimation of the equivalent channel matrix 12 times. For this reason, the channel estimator 76 in the UE 1 can estimate the equivalent channel matrix 12 times in a case where one stream is transmitted to the UE 1 and two streams are transmitted to the other UE, namely the UE 2. In a case where the UE is subjected to NOMA, the transmission powers for the DM-RSs differ depending on the number of streams transmitted to each UE (see FIGS. 8, 9, and 12). Therefore, the channel estimator 76 adjusts the equivalent channel matrix in accordance with the number of streams transmitted to each UE. On the other hand, in a case where the UE is not subjected to NOMA, the base station 10 transmits DM-RSs of respective streams with a fixed power. Thus, the channel estimator 76 does not adjust the equivalent channel matrix.

In the second embodiment, in a case where the UE is subjected to NOMA and one stream is transmitted to each of two UEs from the base station, the resource elements RE1 are allocated to the DM-RSs for this UE as shown in FIG. 13. The DM-RS recognizer 74 references the resource elements RE1 to recognize the DM-RSs. Because a two-symbol length orthogonal spreading code is used, the channel estimator 76 estimates the equivalent channel matrix using a DM-RS with two consecutive OFDM symbols. With one resource block RB, the channel estimator 76 estimates the equivalent channel matrix six times for each stream (layer).

In the second embodiment, in a case where the UE is subjected to NOMA and two streams are transmitted to each of two UEs from the base station, the resource elements RE1 and RE2 are allocated to the DM-RSs for the subject UE as shown in FIG. 14. In a case where one stream is transmitted to one UE and two streams are transmitted to another UE from the base station, the resource elements RE1 and RE2 are allocated to the DM-RSs for the subject UE as shown in FIG. 15. In either case, the DM-RS recognizer 74 references the resource elements RE1 and RE2 to recognize the DM-RSs. Also, in either case, a four-symbol length orthogonal spreading code is used. The channel estimator 76 thus estimates the equivalent channel matrix using a DM-RS with four OFDM symbols. With one resource block RB, the channel estimator 76 estimates the equivalent channel matrix three times for each stream (layer). In the second embodiment, in a case where the UE is subjected to NOMA, the transmission powers for the DM-RSs differ depending on the number of streams transmitted to each UE (see FIGS. 13, 14, and 15). Therefore, the channel estimator 76 adjusts the equivalent channel matrix in accordance with the number of streams transmitted to each UE.

Accordingly, it is favorable that the serving base station signals, to the UEs, information regarding the number of streams to be transmitted to each UE subjected to NOMA, in addition to information regarding whether the UEs are subjected to NOMA. It is favorable that, based on this information, each UE can distinguish the resource elements to be referenced by the DM-RS recognizer 74 in the UE to recognize the DM-RSs for the subject UE, distinguish the symbol length of each DM-RS with which the channel estimator 76 estimates the equivalent channel matrix, and distinguish whether to adjust the equivalent channel matrix.

The UE includes the channel estimator 76 for estimating a downlink equivalent channel matrix based on the DM-RS of each stream. In a case where the radio receiver 64 receives, from the base station, a desired data signal that is not mixed with a non-orthogonal signal (in a case where the UE is not subjected to NOMA), the channel estimator 76 does not adjust the equivalent channel matrix. In a case where the radio receiver 64 receives, from the base station, a mixed data signal that includes non-orthogonal multiple data signals having different powers respectively addressed to multiple UEs (in a case where the UE is subjected to NOMA), the channel estimator 76 adjusts the equivalent channel matrix in accordance with the number of streams transmitted to each UE from the base station. Accordingly, the channel matrix can be appropriately adjusted even in a case where the number of streams differs between UEs and the number of DM-RSs differs between UEs but the transmission powers at the resource elements for the DM-RSs are equalized by the base station.

### DESCRIPTION OF REFERENCE SIGNS

1, 2, 100 to 102 UE (user equipment)
10 base station
10a cell area
30 controller
32 radio transmitter
33 transmission antenna
34 radio receiver
35 reception antenna
36 inter-base station communicator
38 CQI reporting processor
40 DM-RS generator (demodulation reference signal generator, resource element allocator)
42 CSI-RS generator
44 control signal generator
46 scheduler (resource element allocator)
48 downlink transmission power determiner
50 stream transmission power determiner
52 precoder
54 signal spreader
60 controller
62 radio transmitter
63 transmission antenna
64 radio receiver
65 reception antenna
70 reception quality measurer
71 CQI reporter
72 control signal recognizer
74 DM-RS recognizer (demodulation reference signal recognizer)
76 channel estimator
78 non-orthogonal signal demodulator
80 non-orthogonal signal canceler
82 desired data signal demodulator/decoder (desired data signal demodulator)

1. A base station comprising:
a downlink transmission power determiner configured to allocate different downlink transmission powers to a plurality of user equipments, wherein one of the different downlink transmission powers is allocated to each of the plurality of user equipments in accordance with reception qualities of the user equipments;
a stream transmission power determiner configured to determine, in accordance with the number of streams to be transmitted to each of the plurality of user equipments and the downlink transmission powers determined by the downlink transmission power determiner, transmission powers for respective streams to be transmitted to the plurality of user equipments;
a precoder configured to perform different precodings on data signals addressed to the plurality of user equipments, and perform, on each of demodulation reference signals to be transmitted in the respective streams in which the data signals are transmitted, the same precoding as the precoding performed on the corresponding data signal;
a radio transmitter configured to transmit a mixed data signal in which a plurality of non-orthogonal data signals addressed to respective ones of the plurality of user equipments are mixed, such that the data signals are transmitted in the respective streams, with the transmission powers determined by the stream transmission power determiner, the radio transmitter further being configured to transmit the demodulation reference signals; and
a resource element allocator configured to allocate the demodulation reference signals to the streams to be transmitted to the user equipments, and determine, in accordance with the number of streams to be transmitted to one of the user equipments and the number of streams to be transmitted to an other of the user equipments, transmission powers for the demodulation reference signals for each of the one and other user equipments, to determine the number of resource elements to be allocated to the demodulation reference signals for each of the one and other user equipments.

2. The base station according to claim 1,
wherein the resource element allocator determines the transmission powers for the demodulation reference signals for the one and the other user equipments in accordance with whether the streams to be transmitted to the user equipments are to be orthogonally multiplexed or non-orthogonally multiplexed, and determines the number of resource elements to be allocated to the demodulation reference signals for each of the one and the other user equipments.

3. The base station according to claim 1,
wherein when the number of streams to be transmitted to the one user equipment differs from the number of streams to be transmitted to the other user equipment, the resource element allocator allocates shared resource elements to the demodulation reference signals for each of the one and the other user equipments, such that transmission powers at the shared resource elements are equalized.

4. The base station according to claim 3,
wherein when the number of streams to be transmitted to the one user equipment differs from the number of streams to be transmitted to the other user equipment, the resource element allocator allocates, as the shared resource elements, resource elements appropriate for either the one user equipment or the other user equipment to which a larger number of streams is to be transmitted, to the demodulation reference signals for the one and other user equipments.

5. The base station according to claim 4,
wherein when the number of streams to be transmitted to the one user equipment differs from the number of streams to be transmitted to the other user equipment, the resource element allocator allocates a plurality of different resource elements to demodulation reference signals of a plurality of streams for either the one user equipment or the other user equipment to which the larger number of streams is to be transmitted, and the resource element allocator redundantly allocates the plurality of resource elements allocated to either the one user equipment or the other user equipment to which the larger number of streams is to be transmitted, to a demodulation reference signal of a single stream for either the one user equipment or the other user equipment to which a smaller number of streams is to be transmitted.

6. The base station according to claim 4,
wherein the resource element allocator allocates the shared resource elements to the demodulation reference signals of all the streams regardless of the user equipments to which the demodulation reference signals are addressed.

7. A user equipment comprising:
a radio receiver configured to receive a desired data signal and a demodulation reference signal from a base station;
a non-orthogonal signal canceler configured to, if the radio receiver receives from the base station a mixed data signal that includes a plurality of non-orthogonal data signals respectively addressed to a plurality of user equipments and having different powers and when a power of the desired data signal addressed to the subject user equipment is lower than a power of one non-orthogonal data signal, out of the non-orthogonal data signals, addressed to an other user equipment, cancel out, from the mixed signal, a replica signal that is equivalent to the non-orthogonal data signal mixed with the desired data signal;
a desired data signal demodulator configured to demodulate the desired data signal by using the demodulation reference signal received by the radio receiver;
a demodulation reference signal recognizer configured to reference different resource elements in accordance with the number of streams transmitted to the user equipment from the base station, to recognize a demodulation reference signal of each stream; and
a channel estimator configured to estimate a downlink channel matrix based on the demodulation reference signal of each stream recognized by the demodulation reference signal recognizer,
wherein if the radio receiver receives, from the base station, the desired data signal that is not mixed with the non-orthogonal signal, the channel estimator does not adjust the channel matrix, and
if the radio receiver receives, from the base station, the mixed data signal that includes the non-orthogonal data signals respectively addressed to the user equipments and having different powers, the channel estimator adjusts the channel matrix in accordance with the number of streams transmitted to each user equipment from the base station.

8. A radio communication system comprising:
a base station; and
a plurality of user equipments,
the base station comprising:
a downlink transmission power determiner configured to allocate different downlink transmission powers to the plurality of user equipments, wherein one of the different downlink transmission powers is allocated to each of the plurality of user equipments in accordance with reception qualities of the user equipments;
a stream transmission power determiner configured to determine, in accordance with the number of streams to be transmitted to each of the plurality of user equipments and the downlink transmission powers determined by the downlink transmission power determiner, transmission powers for respective streams to be transmitted to the plurality of user equipments;
a precoder configured to perform different precodings on data signals addressed to the plurality of user equipments, and perform, on each of demodulation reference signals to be transmitted in the respective streams in which the data signals are transmitted, the same precoding as the precoding performed on the corresponding data signal;
a radio transmitter configured to transmit a mixed data signal in which a plurality of non-orthogonal data signals addressed to respective ones of the plurality of user equipments are mixed, such that the data signals are transmitted in the respective streams, with the transmission powers determined by the stream transmission power determiner, the radio transmitter further being configured to transmit the demodulation reference signals; and
a resource element allocator configured to allocate the demodulation reference signals to the streams to be transmitted to the user equipments, and determine, in accordance with the number of streams to be transmitted to one of the user equipments and the number of streams to be transmitted to an other of the user equipments, transmission powers for the demodulation reference signals for each of the one and other user equipments, to determine the number of resource elements to be allocated to the demodulation reference signals for each of the one and other user equipments, and
each user equipment comprising:
a radio receiver configured to receive a desired data signal and a demodulation reference signal from the base station;
a non-orthogonal signal canceler configured to, if the radio receiver receives from the base station the mixed data signal that includes the plurality of non-orthogonal data signals respectively addressed to the plurality of user equipments and having different powers and when a power of the desired data signal addressed to the subject user equipment is lower than a power of one non-orthogonal data signal, out of the non-orthogonal data signals, addressed to an other user equipment, cancel out, from the mixed signal, a replica signal that is equivalent to the non-orthogonal data signal mixed with the desired data signal;
a desired data signal demodulator configured to demodulate the desired data signal by using the demodulation reference signal received by the radio receiver;
a demodulation reference signal recognizer configured to reference different resource elements in accordance with the number of streams transmitted to the user equipment from the base station, to recognize a demodulation reference signal of each stream; and
a channel estimator configured to estimate a downlink channel matrix based on the demodulation reference signal of each stream recognized by the demodulation reference signal recognizer,
wherein if the radio receiver receives, from the base station, the desired data signal that is not mixed with the non-orthogonal signal, the channel estimator does not adjust the channel matrix, and
if the radio receiver receives, from the base station, the mixed data signal that includes the non-orthogonal data signals respectively addressed to the user equipments and having different powers, the channel estimator adjusts the channel matrix in accordance with the number of streams transmitted to each user equipment from the base station.

9. The base station according to claim 2,
wherein when the number of streams to be transmitted to the one user equipment differs from the number of streams to be transmitted to the other user equipment, the resource element allocator allocates shared resource elements to the demodulation reference signals for each of the one and the other user equipments, such that transmission powers at the shared resource elements are equalized.

10. The base station according to claim 9,
wherein when the number of streams to be transmitted to the one user equipment differs from the number of streams to be transmitted to the other user equipment, the resource element allocator allocates, as the shared resource elements, resource elements appropriate for either the one user equipment or the other user equipment to which a larger number of streams is to be transmitted, to the demodulation reference signals for the one and other user equipments.

11. The base station according to claim 10,
wherein when the number of streams to be transmitted to the one user equipment differs from the number of streams to be transmitted to the other user equipment, the resource element allocator allocates a plurality of different resource elements to demodulation reference signals of a plurality of streams for either the one user equipment or the other user equipment to which the larger number of streams is to be transmitted, and the resource element allocator redundantly allocates the plurality of resource elements allocated to either the one user equipment or the other user equipment to which the larger number of streams is to be transmitted, to a demodulation reference signal of a single stream for either the one user equipment or the other user equipment to which a smaller number of streams is to be transmitted.

12. The base station according to claim 10,
wherein the resource element allocator allocates the shared resource elements to the demodulation reference signals of all the streams regardless of the user equipments to which the demodulation reference signals are addressed.

13. The radio communication system according to claim 8,
wherein the resource element allocator determines the transmission powers for the demodulation reference signals for the one and the other user equipments in accordance with whether the streams to be transmitted to the user equipments are to be orthogonally multiplexed or non-orthogonally multiplexed, and determines the number of resource elements to be allocated to the demodulation reference signals for each of the one and the other user equipments.

14. The radio communication system according to claim 8,
wherein when the number of streams to be transmitted to the one user equipment differs from the number of streams to be transmitted to the other user equipment, the resource element allocator allocates shared resource elements to the demodulation reference signals for each of the one and the other user equipments, such that transmission powers at the shared resource elements are equalized.

15. The radio communication system according to claim 14,
wherein when the number of streams to be transmitted to the one user equipment differs from the number of streams to be transmitted to the other user equipment, the resource element allocator allocates, as the shared resource elements, resource elements appropriate for either the one user equipment or the other user equipment to which a larger number of streams is to be transmitted, to the demodulation reference signals for the one and other user equipments.

16. The radio communication system according to claim 15,
wherein when the number of streams to be transmitted to the one user equipment differs from the number of streams to be transmitted to the other user equipment, the resource element allocator allocates a plurality of different resource elements to demodulation reference signals of a plurality of streams for either the one user equipment or the other user equipment to which the larger number of streams is to be transmitted, and the resource element allocator redundantly allocates the plurality of resource elements allocated to either the one user equipment or the other user equipment to which the larger number of streams is to be transmitted, to a demodulation reference signal of a single stream for either the one user equipment or the other user equipment to which a smaller number of streams is to be transmitted.

17. The radio communication system according to claim 15,
wherein the resource element allocator allocates the shared resource elements to the demodulation reference signals of all the streams regardless of the user equipments to which the demodulation reference signals are addressed.
